(19) United States
(12) Patent Application Publication
(10) Pub. No.: US 2025/0162594 A1
(43) Pub. Date: May 22, 2025

(54) ESTIMATION OF A COEFFICIENT OF FRICTION FOR A SURFACE RELATIVE TO ONE OR MORE TIRES IN CONTACT WITH THE SURFACE

(71) Applicants: Bridgestone Americas Tire Operations, LLC, Nashville, TN (US); ClearMotion, Inc., Billerica, MA (US)

(72) Inventors: Masoud Ansari, Copley, OH (US); Terence Eugene Wei, Copley, OH (US); Hans Robert Dorfi, Akron, OH (US); Philip Michael Severyn, North Canton, OH (US); Srikrishna Doraiswamy, Aurora, OH (US); Patrick Ryan Moga, Uniontown, OH (US); Michael Francis Gessner, Akron, OH (US); Joseph Stephen Divoky, Uniontown, OH (US); Stanley Ikenedum Omeike, Cleveland Heights, OH (US)

(21) Appl. No.: 18/839,607

(22) PCT Filed: Feb. 15, 2023
(86) PCT No.: PCT/US2023/062626

§ 371 Date: Aug. 19, 2024

Related U.S. Application Data
(60) Provisional application No. 63/311,847, filed on Feb. 18, 2022.

(51) Int. Cl. B60W 40/068; B60W 50/14

(52) U.S. Cl. CPC B60W 40/068; B60W 50/14; B60W 2050/146

(57) ABSTRACT

A method for estimating a coefficient of friction for a surface relative to one or more tires in contact with the surface, the one or more tires mounted on a vehicle, is disclosed herein. One or more models may be selectively retrieved from data storage. At least one surface condition may be associated with each of the one or more models. Respective values corresponding to a coefficient of friction of the surface relative to the one or more tires in contact with the surface may be estimated based on at least the one or more models and at least one of the one or more operating events on, and a sensed motion of, at least one of the one or more tires. At least one output signal corresponding to the estimated coefficient of friction may be generated.

### FIELD OF THE DISCLOSURE

The present disclosure relates generally to quantifying performance aspects of tires on wheeled motor vehicles. More particularly, systems, methods, and related algorithms as disclosed herein relate to an estimation of a coefficient of friction for a surface relative to one or more tires mounted on wheeled motor vehicles, including but not limited to motorcycles, consumer vehicles (e.g., passenger and light truck), commercial and off-road (OTR) vehicles, and various performance aspects of such vehicles based on an improved estimation of coefficient of friction, wherein the estimated coefficient of friction is based on at least a motion of the tires mounted on the wheeled motor vehicles, as provided substantially from tire-mounted sensors communicatively linked to a computing device.

### BACKGROUND

Contact between one or more tires mounted on a wheeled motor vehicle and a surface is instrumental in enabling the wheeled motor vehicle to accelerate, decelerate, steer, turn, or otherwise maneuver about or across the surface. The one or more tires mounted on a wheeled motor vehicle may be subjected to various surface conditions, including pavement, concrete, asphalt, or other external factors, including dry, wet, or icy surfaces. These surface conditions may undesirably impact an operation of the vehicle by adversely affecting any of the following user inputs: accelerating, decelerating, steering, turning, or otherwise maneuvering the vehicle. Not surprisingly, changes in the surface conditions of the surface in contact with the one or more tires mounted on the wheeled motor vehicle may yield poor vehicle stability and tire traction. Consequently, such poor vehicle stability and tire traction has undermined, challenged, or otherwise affected active safety systems in the vehicle, including a collision avoidance system (CAS), an advanced drive-assistance system (ADAS), an anti-lock braking system (ABS), an active suspension system (ASS), or an adaptive cruise control system (ACCS).

Given the relationship between the surface conditions of the surface in contact with the one or more tires mounted on a wheeled motor vehicle, current active safety systems either do not take into consideration the characteristics of the various surface conditions of the surface or employ flawed methods of estimating a coefficient of friction for the surface in contact with the one or more tires mounted on the wheeled motor vehicle. Where active safety systems do not take into consideration the characteristics of the various surface conditions, the wheeled motor vehicle, which may be either user-operated or autonomously operated, may experience inefficient acceleration- and deceleration-related performance, as well as undesirable steering or maneuvering on or about the surface.

For those active safety systems employing flawed methods of estimating the coefficient of friction for the surface in contact with the one or more tires mounted on the wheeled motor vehicle, such active safety systems fail to account for abrupt changes in the surface conditions of the surface, including external factors like weather- or climate-related events. These flawed methods of estimating the coefficient of friction rely upon experiment-based or model-based approaches, and combinations thereof. In experiment-based approaches, the methods, and algorithm(s) in support thereof, require a correlation between signals and data received from various sensors, including inertial measurement units (IMUs), acoustic sensors, optical sensors, temperature sensors, and other sensors, and friction-related parameters for a specified surface condition. In model-based approaches, including tire-slip models and vehicle-dynamics models, friction is estimated through the use of mathematical algorithms and rule-based protocols. Specifically, model-based approaches generally estimate the coefficient of friction for the surface in contact with the one or more tires by comparing friction-related parameters, such as slip ratio and slip angle, against measured data and states, including angular velocity.

Flaws in the experiment-based and model-based approaches, and combinations thereof, are especially problematic for automotive safety technologies and active safety systems, including the collision avoidance system (CAS), the advanced drive-assistance system (ADAS), the anti-lock braking system (ABS), the active suspension system (ASS), or the adaptive cruise control system (ACCS). These automotive safety technologies not only fail to account for abrupt changes in the surface conditions of the surface, but also these automotive safety technologies do not factor the characteristics and features of various surface conditions, each of which necessitate their own operating conditions and navigational performance. As a result of the failure to account for the changes in the surface conditions, inefficient performance with respect to an operating event, such as braking, may occur, and the user of the vehicle may be subjected to a vehicular accident.

At least in view of the flaws in experiment-based and model-based approaches, and combinations thereof, to estimating a coefficient of friction for a surface relative to one or more tires in contact with the surface, it would be desirable to provide a system and method for estimating a coefficient of friction for a surface relative to one or more tires in contact with the surface that accounts for abrupt changes in the surface condition of the surface and the characteristics of the various surface conditions.

### BRIEF SUMMARY

In view of the aforementioned deficiencies in experiment-based and model-based approaches, approaches as disclosed herein may be implemented to estimate operational condition indicators, such as for example a coefficient of friction for a surface relative to one or more tires in contact with the surface, that are vital to understanding a performance of the one or more tires when executing one or more operating events with respect to a surface condition of the surface. A system configured accordingly may comprise a tire-mounted sensing unit, a unit for detecting one or more operating events, and novel algorithms to provide users of a vehicle, including cloud-based management entities, with real-time monitoring and predictive analysis as it relates to the surface condition of the surface. Such predictive analysis for the surface condition improves a performance of the vehicle as it encounters various surface conditions of the surface, and provides improvements in various automotive safety technologies and active safety systems, including a collision avoidance system (CAS), an advanced drive-assistance system (ADAS), an anti-lock braking system (ABS), an active suspension system (ASS), or an adaptive cruise control system (ACCS). The system and method disclosed herein having real-time monitoring, coupled with predictive analysis, deters inefficient performance of the vehicle across various surface conditions and prevents, or otherwise mitigates, an accident or collision of the vehicle with another vehicle.

In the context of methods for estimating a coefficient of friction for a surface relative to one or more tires in contact with the surface, certain embodiments of a method are disclosed. The one or more tires may be mounted on a vehicle. One or more operating events on at least one of the one or more tires mounted on the vehicle may be detected. For at least one of the one or more operating events, at least one sensor mounted on the at least one of the one or more tires mounted on the vehicle may receive at least signals representative of a sensed motion. One or more models may be selectively retrieved from data storage. At least one surface condition may be associated with each of the one or more models. The one or more models may have at least an expected motion of the at least one of the one or more tires mounted on the vehicle related to the at least one of the one or more operating events on the at least one of the one or more tires mounted on the vehicle. Respective values corresponding to a coefficient of friction of the surface relative to the one or more tires in contact with the surface may be estimated based on at least the one or more models, the at least one of the one or more operating events, and the sensed motion. At least one output signal corresponding to the estimated coefficient of friction for the surface relative to the one or more tires in contact with the surface may be generated. The estimated coefficient of friction may be used as an input for tire traction models, and the at least one output signal corresponding to the estimated coefficient of friction for the surface relative to the one or more tires in contact with the surface may be provided to a vehicle control unit or an active safety system. The active safety system may include at least one of a collision avoidance system (CAS), an advanced drive-assistance system (ADAS), an anti-lock braking system (ABS), an active suspension system (ASS), or an adaptive cruise control system (ACCS), and combinations thereof.

In the context of a vehicle, certain embodiments of a system for estimating a coefficient of friction for a surface relative to one or more tires in contact with the surface are disclosed. The one or more tires may be mounted on the vehicle. At least one sensor may be mounted on at least one of the one or more tires mounted on the vehicle. The at least one sensor may be configured to receive at least signals representative of a sensed motion of the at least one of the one or more tires mounted on vehicle. The at least signals representative of a sensed motion may be based on one or more operating events on the at least one of the one or more tires mounted on the vehicle. A data storage may have stored thereon one or more models. At least one surface condition may be associated with each of the one or more models. The one or more models may have at least an expected motion of the at least one of the one or more tires mounted on the vehicle corresponding to the at least one of the one or more operating events on the at least one of the one or more tires mounted on the vehicle. A computing device may be communicatively linked to the at least one sensor mounted on the at least one of the one or more tires mounted on the vehicle, and the computing device may be further linked to the data storage. The computing device may be configured to estimate respective values corresponding to a coefficient of friction of the surface relative to the one or more tires in contact with the surface based on at least the one or more models, the at least one of the one or more operating events, and the sensed motion. And, the computing device may be further configured to generate at least one output signal corresponding to the estimated respective values corresponding to the coefficient of friction for the surface relative to the one or more tires in contact with the surface.

In one particular and exemplary embodiment, a method for estimating a coefficient of friction for a surface relative to one or more tires in contact with the surface is provided. The method may commence with a step of detecting one or more operating events on at least one of the one or more tires mounted on the vehicle. The method may continue with a step of receiving at least signals representative of a sensed motion from at least one sensor mounted on the at least one of the one or more tires mounted on the vehicle, for at least one of the one or more operating events. The method may continue with a step of selectively retrieving from data storage one or more models. At least one surface condition is associated with each of the one or more models. The one or more models have at least an expected motion of the at least one of the one or more tires mounted on the vehicle related to the at least one of the one or more operating events on the at least one of the one or more tires mounted on the vehicle. The method may continue with a step of estimating respective values corresponding to a coefficient of friction of the surface relative to the one or more tires in contact with the surface based on at least the one or more models, the at least one of the one or more operating events, and the sensed motion. And, the method may continue with a step of generating at least one output signal corresponding to the estimated respective values corresponding to the coefficient of friction for the surface relative to the one or more tires in contact with the surface.

In one exemplary aspect according to the above-referenced embodiment, the one or more operating events may comprise at least one of an acceleration of the at least one of the one or more tires mounted on the vehicle, an acceleration of the vehicle on which the at least one of the one or more tires are mounted, a deceleration of the at least one of the one or more tires mounted on the vehicle, a deceleration of the vehicle on which the at least one of the one or more tires are mounted, a steering of the at least one of the one or more tires mounted on the vehicle, or a steering of the vehicle on which the at least one of the one or more tires are mounted, and combinations thereof.

In another exemplary aspect according to the above-referenced embodiment, the at least one surface condition may comprise a value corresponding to a coefficient of friction.

In another exemplary aspect according to the above-referenced embodiment, the method may continue with a step of determining a saturation point of the at least one of the one or more tires based at least in part on the at least signals representative of the sensed motion, the sensed motion comprising a sensed acceleration.

In another exemplary aspect according to the above-referenced embodiment, the method may continue with a step of estimating respective values corresponding to the coefficient of friction of the surface relative to the one or more tires in contact with the surface based on at least the one or more models, the at least one of the one or more operating events, and a maximum value of the sensed acceleration corresponding to the determined saturation point.

In another exemplary aspect according to the above-referenced embodiment, the method may continue with a step of estimating respective values corresponding to the coefficient of friction of the surface relative to the one or more tires in contact with the surface based on at least the one or more models, the at least one of the one or more operating events, and a change of rate of the sensed acceleration preceding the determined saturation point.

In another exemplary aspect according to the above-referenced embodiment, the method may continue with a step of calculating a torque of the at least one of the one or more tires based at least in part on the at least signals representative of the sensed motion. The method may further continue with a step of determining a saturation point of the at least one of the one or more tires based at least in part on the calculated torque.

In another exemplary aspect according to the above-referenced embodiment, the method may continue with a step of estimating respective values corresponding to the coefficient of friction of the surface relative to the one or more tires in contact with the surface based on at least the one or more models, the at least one of the one or more operating events, and a change of rate of the calculated torque preceding the determined saturation point.

In another exemplary aspect according to the above-referenced embodiment, the method may continue with a step of determining a footprint length of the at least one of the one or more tires based at least in part on the at least signals representative of the sensed motion. The method may further continue with a step of estimating respective values corresponding to the coefficient of friction of the surface relative to the one or more tires in contact with the surface based on at least the one or more models, the at least one of the one or more operating events, and the determined footprint length.

In another exemplary aspect according to the above-referenced embodiment, the sensed motion may comprise at least one of a sensed lateral acceleration, a sensed longitudinal acceleration, or a sensed radial acceleration, and combinations thereof.

In another exemplary aspect according to the above-referenced embodiment, the method may continue with a step of providing the at least one output signal to a user interface connected to the vehicle for display to a user of the vehicle.

In another exemplary aspect according to the above-referenced embodiment, the method may continue with a step of providing the at least one output signal to a user interface connected to a remote computing device via a cloud-based data-management platform.

In another exemplary aspect according to the above-referenced embodiment, the method may continue with a step of using the estimated respective values corresponding to the coefficient of friction as an input to a tire traction detection model.

In another exemplary aspect according to the above-referenced embodiment, the method may continue with a step of providing the at least one output signal to a vehicle control unit connected to an active safety system.

In another exemplary aspect according to the above-referenced embodiment, the active safety system may comprise at least one of a collision avoidance system (CAS), an advanced drive-assistance system (ADAS), an anti-lock braking system (ABS), an active suspension system (ASS), or an adaptive cruise control system (ACCS), and combinations thereof.

In another embodiment, a system is disclosed herein for estimating a coefficient of friction for a surface relative to one or more tires in contact with the surface, the one or more tires mounted on a vehicle. At least one sensor is mounted on at least one of the one or more tires mounted on the vehicle. The at least one sensor is configured to receive at least signals representative of a sensed motion of the at least one of the one or more tires mounted on the vehicle based on one or more operating events on the at least one of the one or more tires mounted on the vehicle. Stored in data storage is one or more models with at least one surface condition associated with each of the one or more models. The one or more models have at least an expected motion of the at least one of the one or more tires mounted on the vehicle corresponding to the at least one of the one or more operating events on the at least one of the one or more tires mounted on the vehicle. A local controller, remote server, and/or other computing device is communicatively linked to the at least one sensor mounted on the at least one of the one or more tires mounted on the vehicle and the data storage. The local controller, remote server, and/or other computing device is configured to direct the performance of remaining steps or operations from the above-referenced method embodiment and optionally any of the described exemplary aspects thereof.

Unless otherwise defined, all technical and scientific terms used herein have the same meaning as commonly understood by one of ordinary skill in the art to which this invention belongs. The present invention may be embodied in other specific forms without departing from the spirit or essential attributes thereof, and it is therefore desired that the present embodiment be considered in all aspects as illustrative and not restrictive. Any headings utilized in the description are for convenience only and no legal or limiting effect. Numerous objects, features, and advantages of the embodiments set forth herein will be readily apparent to those skilled in the art upon reading of the following disclosure when taken in conjunction with the accompanying drawings.

### BRIEF DESCRIPTION OF THE DRAWINGS

Hereinafter, various exemplary embodiments of the disclosure are illustrated in more detail with reference to the drawings.

FIG. 1 is a block diagram representing an embodiment of system for estimating a coefficient of friction for a surface relative to one or more tires in contact with the surface, as disclosed herein.

FIG. 2 is a flowchart representing an embodiment of a method for estimating a coefficient of friction for a surface relative to one or more tires in contact with the surface, as disclosed herein.

FIG. 3 is a free-body diagram of a tire in contact with a surface, as disclosed herein.

FIGS. 4A-4D are graphical diagrams representing one or more operating events on and an acceleration of at least one of one or more tires mounted on a vehicle measured with respect to a coefficient of friction of a surface relative to the one or more tires in contact with the surface, as disclosed herein.

### DETAILED DESCRIPTION

Reference will now be made in detail to embodiments of the present disclosure, one or more drawings of which are set forth herein. Each drawing is provided by way of explanation of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features, and aspects of the present disclosure are disclosed in, or are obvious from, the following detailed description. It is to be understood by one of ordinary skill in the art that the present discussion is a description of exemplary embodiments only and is not intended as limiting the broader aspects of the present disclosure.

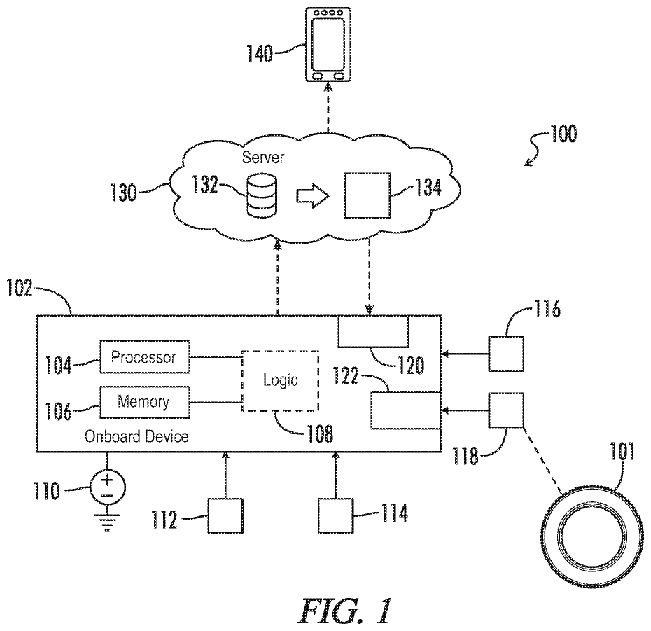

Referring generally to FIGS. 1-4D, various exemplary embodiments may now be described of a system and method for estimating a coefficient of friction for a surface relative to one or more tires in contact with the surface. Where the various figures may describe embodiments sharing various common elements and features with other embodiments, similar elements and features are given the same reference numerals and redundant description thereof may be omitted below. A system 100 according to certain embodiments may include, and/or a method 200 according to certain embodiments may be executed by, a computing device 102 that is local and for example resides in association with a vehicle, or a computing device 130, 140 that is remote and for, example, is part of a cloud-based network or a fleet management system, or some combination thereof within the scope of the present disclosure. Centralized or distributed data processing may accordingly be implemented based on inputs from specified sensors, or to at least initiate the generation of output signals are further described herein to specified interfaces, control systems, or actuators, without limitation unless otherwise specifically stated.

Referring initially to FIG. 1, one exemplary embodiment of a system 100 as disclosed herein includes the computer device 102, or a data acquisition device 102, that is onboard a vehicle and configured to perform relevant computations as disclosed herein, and/or to at least obtain data and transmit said data to one or more downstream computing devices, such as a remote server 130 or a user computing device 140, to perform relevant computations as disclosed herein. The data acquisition device 102 may be a standalone sensor unit (not shown) appropriately configured to collect raw measurement signals, such as for example signals corresponding to a radial acceleration, a contained air pressure, and/or an inflation pressure of a tire 101, or a longitudinal acceleration or a lateral acceleration of the tire 101, or the vehicle on which the tire 101 is mounted, and to continuously or selectively transmit such signals to downstream computing devices, such as a remote server 130 or a user computing device 140. For the purpose of the disclosure, when referring to a longitudinal acceleration or a lateral acceleration of the tire 101, the longitudinal acceleration or the lateral acceleration may refer to an acceleration of the tire 101 itself and/or the vehicle on which the tire 101 is mounted. The data acquisition device 102 may comprise an onboard computing device 102 in communication with one or more distributed sensors and which is portable or otherwise modular as part of a distributed vehicle data collection and control system, or otherwise may be integrally provided with respect to a central vehicle data collection control system. The data acquisition device 102, or the onboard computing device 102, may include a processor 104 and a memory 106 having program logic 108 residing thereon, and in various embodiments may comprise a vehicle electronic control unit (ECU) or a component thereof, or otherwise may be discrete in nature, for example permanently or detachably provided with respect to a vehicle mount.

Generally stated, a system 100 as disclosed herein may implement numerous components distributed across one or more vehicles, for example but not necessarily associated with a fleet management entity, and further a central server network or event-driven serverless platform in functional communication with each of the vehicles via a communications network.

The illustrated embodiment of the system 100 may include for illustrative purposes, without otherwise limiting the scope of the present disclosure thereby, a tire-mounted sensor (TMS) unit 118 comprising at least one sensor 118 mounted on at least one of one or more tires 101 mounted on a vehicle, an ambient temperature sensor 112, a vehicle speed sensor 114 or a machine control sensor 114 configured to collect, for example, acceleration data associated with the vehicle or configured to detect one or more operating events of the vehicle, position sensors 116 such as global positioning system (GPS) transponders, and a DC power source 110. The tire mounted sensor unit 118 may include one or more sensors configured to generate output signals corresponding to tire conditions related to, or associated with, a motion of the one or more tires 101, or a motion of the vehicle on which the one or more tires 101 are mounted, including any or all of acceleration, such as longitudinal acceleration, lateral acceleration, or radial acceleration, velocity, angular velocity, tire deflection, tire strain, contained air temperature, inflation pressure, acoustic pressure, and the like, and such sensors may take any of various forms known to one of skill in the art for providing such signals. The at least one sensor 118 may be mounted on an inner liner, or some other structural component, of the at least one of the one or more tires 101 mounted on the vehicle. Various bus interfaces, protocols, and associated networks are well known in the art for the communication between the respective data sources and the local computing device 102 and/or the server 130, including for example an onboard receiver 122, and one of skill in the art would recognize a wide range of such tools and means for implementing the same.

In optional embodiments, data acquisition devices and equivalent data sources as disclosed herein, including the data acquisition device 102, are not necessarily limited to vehicle-specific sensors and/or gateway devices, and can also include third party entities and associated networks, program applications resident on a user computing device 140 such as a driver interface, a cloud-based data-management interface, a fleet management interface, and any enterprise devices or other providers of raw streams of logged data as may be considered relevant for algorithms and models as disclosed herein.

In some embodiments, one or more of the various sensors, including the ambient temperature sensor 112, the vehicle speed sensor 114, the position sensors 116, and the tire-mounted sensor unit 118, may be configured to communicate with downstream platforms without a local vehicle-mounted device or gateway components, such as for example via cellular communication networks or via a mobile computing device (not shown) carried by a user of the vehicle.

The term “user interface” as used herein may, unless otherwise stated, include any input-output module by which a user device facilitates user interaction with respect to a processing unit, server, device, or the like as disclosed herein including, but not limited to: downloaded or otherwise resident program applications; web browsers; web portals, such as individual web pages or those collectively defining a hosted website; and the like. A user interface may further be described with respect to a personal mobile computing device in the context of buttons and display portions which may be independently arranged or otherwise interrelated with respect to, for example, a touch screen, and may further include audio and/or visual input/output functionality even without explicit user interactivity. A user interface may additional be described with respect to a dashboard display housed within the interior of the vehicle in the context of buttons, knobs, and/or display portions that may be independently arranged or otherwise interrelated with respect to, for example, a touch screen, audio and/or visual input/output functionality, knobs or buttons configured to alter, for example, audio, radio frequencies, or air conditioning and/or heating, a dash instrument panel, or a heads-up display (HUD).

In optional embodiments, vehicle and tire sensors, including the ambient temperature sensor 112, the vehicle speed sensor 114, the position sensors 116, and the tire-mounted sensor unit 118, may further be provided with unique identifiers, wherein an onboard device processor can distinguish between signals provided from respective sensors on a same vehicle, and further in certain embodiments wherein a central processing unit and/or fleet maintenance supervisor client device may distinguish between signals provided from tires and associated vehicle and/or tire sensors across a plurality of vehicles. In other words, sensor output values may in various embodiments be associated with a particular tire, a particular vehicle, and/or a particular tire-vehicle system for the purposes of onboard or remote/downstream data storage and implementation for calculations as disclosed herein. An onboard data acquisition device 102 may communicate directly with the downstream processing stage 130, such as the remote server 130, as depicted in FIG. 1, or alternatively the user's mobile device or truck-mounted computing device may be configured to receive and process/transmit onboard device output data to one or more downstream processing units.

Raw signals received from at least one sensor mounted on at least one of one or more tires mounted on the vehicle 118, also referred to as to the tire-mounted sensor unit 118, as well as the ambient temperature sensor 112, the vehicle speed sensor 114, and the position sensors 116, may be stored in onboard device memory 106, or an equivalent local data storage network functionally linked to the onboard device processor 104, for selective retrieval and transmittal via a data pipeline stage as needed for calculations according to the method disclosed herein. A local or downstream “data storage network” as used herein may refer generally to individual, centralized, or distributed logical and/or physical entities configured to store data and enable selective retrieval of data therefrom, and may include for example, but without limitation, a memory, look-up tables, files, registers, databases, database services, and the like. In some embodiments, raw data signals from the various sensors, including the ambient temperature sensor 112, the vehicle speed sensor 114, the position sensors 116, and the tire-mounted sensor unit 118, may be communicated substantially in real time from the vehicle to a downstream processing unit such as the remote server 130. Alternatively, particularly in view of the inherent inefficiencies in continuous data transmission of high frequency data, the data may for example be compiled, encoded, and/or summarized for more efficient (e.g., periodic time-based or alternatively defined event-based) transmission from an onboard device (i.e., associated with the vehicle) to a remote processing unit via an appropriate (e.g., cellular) communications network.

Vehicle data and/or tire data, once transmitted via a communications network to a downstream processing unit, such as the remote server 130, or equivalent processing system, may be stored for example in a database 132 associated therewith and further processed or otherwise retrievable as inputs for processing via one or more algorithmic models 134 as disclosed herein. The models 134 may be implemented at least in part via execution of a processor, enabling selective retrieval of the vehicle data and/or tire data and further in electronic communication for the input of any additional data or algorithms from a database, lookup table, or the like that is stored in association with the processing unit.

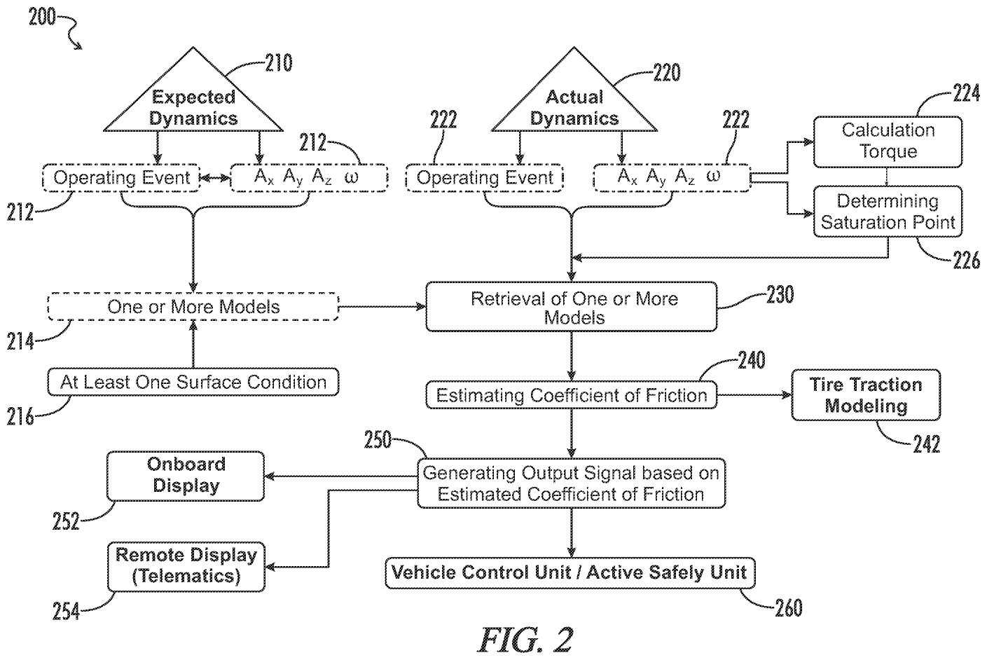

Referring hereafter to FIG. 2, various embodiments of a method 200 may now be described for estimating a coefficient of friction for a surface 160 relative to the one or more tires 101 in contact with the surface 160, the one or more tires 101 mounted on the vehicle. Embodiments of a method 200 may comprise a testing stage and model generation stage associated with expected vehicle dynamics, as conveyed in steps 210-216, and a model implementation stage associated with actual vehicle dynamics, as conveyed in steps 220-260, or portions or variations thereof within the scope of the present disclosure. Otherwise stated, models as disclosed herein may initially be generated and subsequently implemented and/or modified by a given entity, or an entity may merely selectively retrieve one or more models for implementation that have been generated by another.

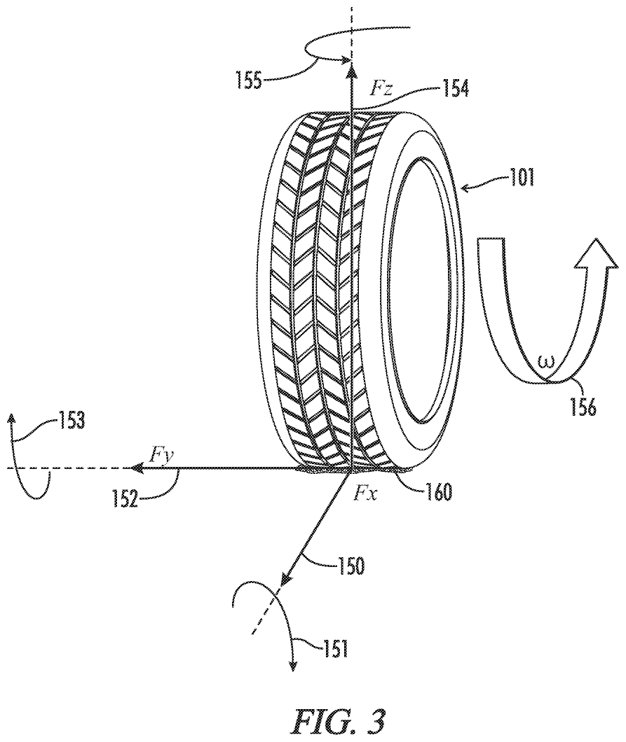

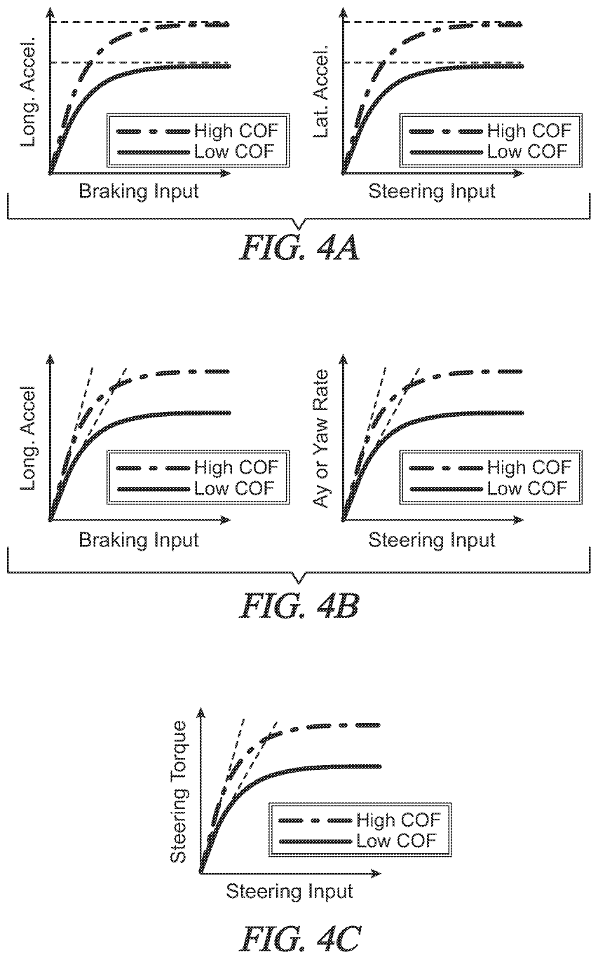

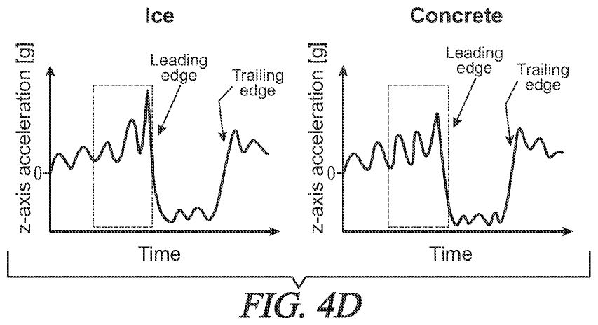

In accordance with the method 200, and referring to the testing and model generation stage associated with the expected vehicle dynamics, as depicted in step 210, various inputs set forth in step 212 are provided for data processing and a generation of one or more models, as depicted in step 214, specific to the one or more tires 101 being tested. At least one surface condition, as depicted by step 216, may be associated, or at least commonly associated with, each of the one or more models, the one or more models of which may be linear or non-linear. In optional embodiments, as illustratively conveyed in FIGS. 3-4D, the various inputs may be collected through offline or online testing, wherein the various inputs in the generation of the one or more models may comprise at least an expected motion of the at least one of the one or more tires 101 mounted on the vehicle related to at least one of the one or more operating events on the at least one of the one or more tires mounted on the vehicle. In optional embodiments, the one or more operating events, as conveyed in the step 212, may include at least one of an acceleration of the at least one of the one or more tires 101 mounted on the vehicle, an acceleration of the vehicle on which the one or more tires 101 are mounted, a deceleration of the at least one of the one or more tires 101 mounted on the vehicle, a deceleration of the vehicle on which the one or more tires 101 are mounted, a steering of the at least one of the one or more tires mounted 101 on the vehicle, or a steering of the vehicle on which the one or more tires 101 are mounted, and combinations thereof.

In other optional embodiments, and referring to FIG. 3, wherein an x-y-z coordinate system in relation to at least one of the one or more tires 101 is illustratively conveyed, the expected motion of the at least one of the one or more tires 101 mounted on the vehicle, or the vehicle on which the at least one of the one or more tires 101 are mounted, may include: a lateral acceleration of the at least one of the one or more tires 101 corresponding to a force exerted in a y-direction (F_{y}) 152 on the at least one of the one or more tires 101, or a rotation 153, or a pitch 153, about the force exerted in the y-direction (F_{y}) 152 on the at least one of the one or more tires 101; a lateral acceleration of the vehicle on which the at least one of the one or more tires 101 are mounted; a longitudinal acceleration of the at least one of the one or more tires 101 corresponding to a force exerted in an x-direction (Fₓ) 150 on the at least one of the one or more tires 101, or a rotation 151, or a roll 151, about the force exerted in an x-direction (Fₓ) 150 on the at least one of the one or more tires 101; a longitudinal acceleration of the vehicle on which the at least one of the one or more tires 101 are mounted; a vertical acceleration of the at least one of the one or more tires 101 corresponding to a normal force exerted in a z-direction (F_{z}) 154, or a rotation 155, or a yaw 155, about the normal force exerted in the z-direction (F_{z}) 154; or a radial acceleration of the at least one of the one or more tires 101 corresponding to an angular velocity (ω) 156. Additional inputs or data corresponding to a saturation point, a footprint length (FPL), or a torque (τ) may be received from the tire-mounted sensor unit 118, or from other sensors, including the vehicle speed sensor 114 or the position sensors 116, either as a direct input or calculated based on other inputs such as the lateral acceleration, the longitudinal acceleration, the vertical acceleration, or the radial acceleration. For the purpose of the disclosure, the expected motion of the at least one of the one or more tires 101 mounted on the vehicle, or the vehicle on which the at least one of the one or more tires 101 are mounted, may include (without limitation) any or all of acceleration, such as longitudinal acceleration, lateral acceleration, or radial acceleration, velocity, angular velocity, tire deflection, tire strain, contained air temperature, inflation pressure, acoustic pressure, and the like.

Referring to FIGS. 2 and 4A-4D, the testing and model generation stage associated with the expected vehicle dynamics of the method 200, as depicted in the step 210, may comprise the generation of one or more models, as depicted in the step 214, specific to the one or more tires 101 being tested. As depicted in FIGS. 4A-4D, a non-linear relationship may be identified between the various inputs received from the vehicle and tire sensors, such as the tire-mounted sensor unit 118. Data underlying the generation of the one or more models, as depicted in the step 214, may be used to create an algorithm. With this algorithm, a relationship may be identified between at least the expected motion and the one or more operating events of the at least one of the one or more tires 101 mounted on the vehicle. In optional embodiments, the generation of the one or more models may be implemented substantially in real time based on actual inputs during operation of the at least one of the one or more tires 101 on the vehicle.

Referring to FIG. 2, with respect to the generation of the one or more models, as depicted in the step 214, and a creation of the algorithm from data underlying the various inputs received from vehicle and tire sensor, the at least one surface condition may be associated, or at least commonly associated with, each of the one or more models, as depicted in the step 216. In optional embodiments, the at least one surface condition may include a surface condition corresponding to a type or a material of the surface 160, including (without limitation) asphalt, concrete, rock (or some other mineral), grass, mud, or dirt, or the at least one surface condition may include a surface condition corresponding to an external factor affecting or impacting the type or the material of the surface 160, including moisture or water, whether due to rainfall or otherwise, iciness, whether due to snow, sleet, or otherwise, or another external factor. In other optional embodiments, the at least one surface condition may include values of a coefficient of friction (μ), including actual, expected values of the coefficient of friction or general categorizations of the expected values of the coefficient of friction, such as a “high,” “medium,” or “low” coefficient of friction.

Referring to FIGS. 2 and 4A-4D, the method 200 may include the model implementation stage associated with the actual vehicle dynamics, as conveyed in step 220. As depicted in step 222, various inputs, including the one or more operating events on the at least one of the one or more tires 101 mounted on the vehicle, may be detected by the tire-mounted sensor unit 118, or from other sensors, including the vehicle speed sensor 114 or the position sensors 116. As further depicted in the step 222, for at least one of the one or more operating events, at least signals representative of a sensed motion may be received by the tire-mounted sensor unit 118—the at least one sensor mounted on the at least one of the one or more tires mounted on the vehicle 118—or from other sensors, including the vehicle sensor 114 or the position sensors 116. In optional embodiments, and as previously disclosed within the context of the step 212, the one or more operating events, as conveyed in step 222, may include at least one of an acceleration of the at least one of the one or more tires 101 mounted on the vehicle, an acceleration of the vehicle on which the at least one of the one or more tires 101 are mounted, a deceleration of the at least one of the one or more tires 101 mounted on the vehicle, a deceleration of the vehicle on which the at least one of the one or more tires 101 are mounted, a steering of the at least one of the one or more tires mounted 101 on the vehicle, or a steering of the vehicle on which the at least one of the one or more tires 101 are mounted, and combinations thereof.

In other optional embodiments, and referring to FIGS. 2-3, wherein an x-y-z coordinate system in relation to at least one of the one or more tires 101 is illustratively conveyed, the sensed motion of the at least one of the one or more tires 101 mounted on the vehicle, or the vehicle on which the at least one of the one or more tires 101 are mounted, may include: a sensed lateral acceleration of the at least one of the one or more tires corresponding to the force exerted in a y-direction (F_{y}) 152 on the at least one of the one or more tires 101, or the rotation 153, or the pitch 153, about the force exerted in the y-direction (F_{y}) 152 on the at least one of the one or more tires 101; a sensed lateral acceleration of the vehicle on which the at least one of the one or more tires 101 are mounted; a sensed longitudinal acceleration of the at least one of the one or more tires 101 corresponding to a force exerted in an x-direction (Fₓ) 150 on the at least one of the one or more tires 101, or the rotation 151, or the roll 151, about the force exerted in an x-direction (Fₓ) 150 on the at least one of the one or more tires 101; a sensed longitudinal acceleration of the vehicle on which the at least one of the one or more tires 101 are mounted; a sensed vertical acceleration of the at least one of the one or more tires 101 corresponding to a normal force exerted in a z-direction (F_{z}) 154, or the rotation 155, or the yaw 155, about the normal force exerted in the z-direction (F_{z}) 154; or a sensed radial acceleration of the at least one of the one or more tires 101 corresponding to an angular velocity (ω) 156. For the purpose of the disclosure, the sensed motion of the at least one of the one or more tires 101 mounted on the vehicle, or the vehicle on which the at least one of the one or more tires 101 are mounted, may include (without limitation) any or all of acceleration, such as longitudinal acceleration, lateral acceleration, or radial acceleration, velocity, angular velocity, tire deflection, tire strain, contained air temperature, inflation pressure, acoustic pressure, and the like.

In further optional embodiments, additional inputs corresponding to the saturation point, the footprint length (FPL), or the torque (τ) may be received, directly or indirectly, from the tire-mounted sensor unit 118, or from other sensors, including the vehicle speed sensor 114 or the position sensors 116. A computing device, whether the onboard data acquisition device 102, the remote server 130, or the user computing device 140, which is communicatively linked to the tire-mounted sensor unit 118, or other sensors, such as the vehicle speed sensor 114 or the position sensors 116, may be configured to determine the saturation point of the at the at least one of the one or more tires 101 mounted on the vehicle based at least in part on the at least signals representative of the sensed motion, as depicted in step 226. “Saturation” is defined as a deficiency or inability of the at least one of the one or more tires 101 to generate an increasing force in a linear manner across either the force exerted in the y-direction (F_{y}) 152—the lateral direction—or the force exerted in the x-direction (Fₓ) 150—the longitudinal direction.

In yet further optional embodiments, the computing device, whether the onboard data acquisition device 102, the remote server 130, or the user computing device 140, which is communicatively linked to the tire-mounted sensor unit 118, or other sensors, such as the vehicle speed sensor 114 or the position sensors 116, may be configured to calculate a torque (τ) from the at least one of the one or more tires 101 mounted on the vehicle based at least in part on the at least signals representative of the sensed motion, as depicted in step 224. The computing device may determine the saturation point of the at least one of the one or more tires 101 mounted on the vehicle based at least in part on the calculated torque, as depicted in the step 226.

In certain embodiments, the footprint length (FPL), the saturation point, or the torque (τ) may be collected or calculated directly or indirectly from the tire-mounted sensor unit 118, or from other sensors, including the vehicle speed sensor 114 or the position sensors 116, and combinations thereof, or the footprint length (FPL), the saturation point, or the torque (τ) may be calculated or determined directly or indirectly by the computing device connected to the various foregoing sensors. In one embodiment, data corresponding to an acceleration waveform of the at least one of the one or more tires 101 may be collected in a radial direction, such as the radial acceleration of the at least one of the one or more tires 101 corresponding to the angular velocity (ω) 156, from sampled outputs of the at least one sensor mounted on the at least one of the one or more tires 101 mounted on the vehicle. The acceleration waveform may then be integrated in the tire radial direction to generate a velocity waveform, wherein a number of samples during ground contact are calculated from at least first and second peaks in the velocity waveform. With respect to footprint length, from a physical understanding of the velocity (integrated acceleration) profile, one of skill in the art may appreciate that the entrance and exit of the ground contact patch (footprint) are identifiable as corresponding with a difference in a number of samples between first and second waveform peaks of the integrated accelerometer signal, accordingly corresponding with the number of samples taken in a footprint area.

Referring to FIG. 2, the model implementation stage associated with the actual vehicle dynamics of the method 200 may continue with a step 230, wherein the one or more models, as depicted in the step 214, are selectively retrieved. Selective retrieval of the one or more models may be performed by a user-initiated event or through an automatic, non-manual event. At least one surface condition, as set forth in the step 216, may be associated, or at least be commonly associated, with each of the one or more models. The model implementation stage associated with the actual vehicle dynamics of the method 200 may further continue with an estimation of respective values corresponding to a coefficient of friction of the surface 160 relative to the one or more tires 101 in contact with the surface 160, as depicted in step 240. The computing device, whether the onboard data acquisition device 102, the remote server 130, or the user computing device 140, may estimate the respective values corresponding to the coefficient of friction of the surface 160 relative to the one or more tires 101 in contact with the surface 160 based on at least the one or more models, the at least one of the one or more operating events, and the sensed motion.

Referring to FIGS. 2 and 4A, graphical diagrams representing one or more operating events on and an acceleration of the at least one of the one or more tires 101 mounted on the vehicle is depicted. In the graphical diagrams of FIG. 4A, the one or more operating events may comprise a braking input on, or a deceleration of, the at least one of the one or more tires 101 mounted on the vehicle, or a steering input on the at least one of the one or more tires 101 mounted on the vehicle. When the at least one of the one or more operating events, such as the braking input or the steering input, is measured against the sensed motion including the sensed acceleration, such as the sensed longitudinal acceleration or the sensed lateral acceleration, of the at least one of the one or more tires 101 mounted on the vehicle, at least one surface condition corresponding to a value of a coefficient of friction, such as a “high” or “low” coefficient of friction, may be ascertained with respect to a maximum value of the acceleration when the at least one of the one or more tires 101 has achieved a point of saturation. Specifically in the step 240, the method 200 may continue with the estimation of the respective values corresponding to the coefficient of friction of the surface 160 relative to the one or more tires 101 in contact with the surface 160 based on at least the one or more non-linear models, the at least one of the one or more operating events, and a maximum value of the sensed acceleration corresponding to the determined saturation point, as depicted in the step 226. As depicted in FIG. 4A, the maximum value of the sensed acceleration, such as the sensed lateral acceleration or the sensed longitudinal acceleration, corresponding to the determined saturation point is evidenced by a horizontal dashed line having a slope value of approximately, or at, zero. The graphical diagram of FIG. 4A conveys simplified curves representing a generally mean line of data corresponding to the sensed acceleration across the at least one of the one or more operating events.

Referring to FIGS. 2 and 4B, graphical diagrams representing one or more operating events on and an acceleration of the at least one of the one or more tires 101 mounted on the vehicle is depicted. In the graphical diagrams of FIG. 4B, the one or more operating events may comprise a braking input on, or a deceleration of, the at least one of the one or more tires 101 mounted on the vehicle, or a steering input on the at least one of the one or more tires 101 mounted on the vehicle. When the at least one of the one or more operating events, such as the braking input or the steering input, is measured against the sensed motion including the sensed acceleration, such as the sensed longitudinal acceleration or the sensed lateral acceleration, or the yaw about the normal force exerted on the at least one of the one or more tires 101 mounted on the vehicle, at least one surface condition corresponding to a value of a coefficient of friction, such as a “high” or “low” coefficient of friction, may be ascertained with respect to a change of rate of acceleration preceding the point of saturation for the at least one of the one or more tires 101 mounted on the vehicle. Specifically, in the step 240, the method 200 may continue with the estimation of the respective values corresponding to the coefficient of friction of the surface 160 relative to the one or more tires 101 in contact with the surface 160 based on at least the one or more non-linear models, the at least one of the one or more operating events, and a change of rate of the sensed acceleration preceding the determined saturated point, as depicted in the step 226. As depicted in FIG. 4B, the change of rate of the sensed acceleration, such as the sensed longitudinal acceleration or the sensed lateral acceleration, or the yaw about the normal force exerted on the at least one of the one or more tires 101, preceding the determined saturation point is evidenced by a dashed line having a slope value of greater than zero. The graphical diagrams of FIG. 4B conveys simplified curves representing a generally mean line of data corresponding to the sensed acceleration across the at least one of the one or more operating events.

Referring to FIGS. 2 and 4C, a graphical diagram representing one or more operating events on and an acceleration of the at least one of the one or more tires 101 mounted on the vehicle is depicted. In the graphical diagram of FIG. 4C, the one or more operating events may comprise a steering input on the at least one of the one or more tires 101 mounted on the vehicle. When the at least one of the one or more operating events, such as the steering input, is measured against a values of torque (τ) calculated from the sensed motion, including the sensed acceleration, of the at least one of the one or more tires 101 mounted on the vehicle, at least one surface condition corresponding to a value of a coefficient of friction, such as a “high” or “low” coefficient of friction, may be ascertained with respect to a change of rate of the calculated torque preceding the point of saturation for the at least one of the one or more tires 101 mounted on the vehicle. Specifically, in the step 240, the method may continue with the estimation of the respective values corresponding to the coefficient of friction of the surface 160 relative to the one or more tires 101 in contact with the surface 160 based on at least the one or more non-linear models, the at least one of the one or more operating events, and a change of rate of the calculated torque preceding the determined saturated point, as depicted in the step 224 and the step 226. As depicted in FIG. 4C, the change of rate of the calculated torque preceding the determined saturation point is evidenced by a dashed line having a slope value of greater than zero. The graphical diagram of FIG. 4C conveys simplified curves representing a generally mean line of data corresponding to the calculated torque across the at least one of the one or more operating events.

Referring to FIGS. 2 and 4D, graphical diagrams representing one or more operating events on and an acceleration of the at least one of the one or more tires 101 mounted on the vehicle is depicted. In the graphical diagrams of FIG. 4D, when the at least one of the one or more operating events, such as the steering input or braking input, is measured against the sensed motion, including the sensed acceleration, of the at least one of the one or more tires 101 mounted on the vehicle, at least one surface condition corresponding to a type or a material of the surface 160, such as concrete, or at least one surface condition corresponding to an external factor, such as iciness, may be ascertained with respect to a trailing edge and a leading edge of the at least one of the one or more tires 101 mounted on the vehicle, commonly associated with a footprint length (FPL) or contact patch of the at least one of the one or more tires 101. In the graphical diagram of FIG. 4D, the sensed acceleration of the at least one of the one or more tires 101 may constitute the radial acceleration of the at least one of the one or more tires 101 corresponding to the angular velocity (ω) 156. Specifically, in the step 240, the method 200 may continue with the estimation of the respective values corresponding to the coefficient of friction of the surface 160 relative to the one or more tires 101 in contact with the surface 160 based on at least the one or more non-linear models, the at least one of the one or more operating events, and a footprint length (FPL) calculated from the radial acceleration of the at least one of the one or more tires 101. The graphical diagrams of FIG. 4D conveys simplified curves representing a generally mean line of data corresponding to the radial acceleration of the at least one or more tires 101 due from the at least one of the one or more operating events.

Referring to FIG. 2, in optional embodiments, the model implementation stage associated with the actual vehicle dynamics of the method 200 may continue with a step 242. The estimated respective values corresponding to the coefficient of friction of the surface 160 relative to the one or more tires 101 in contact with the surface 160 may be used as an input for a tire traction model, as depicted in the step 242. A tire wear status (e.g., tread depth) may for example be provided along with the above-referenced estimated coefficient of friction as inputs to a tire traction model, which may be configured to provide an estimated traction status or one or more traction characteristics for the respective tire. As with the aforementioned wear model, the traction model may comprise “digital twin” virtual representations of physical parts, processes, or systems wherein digital and physical data are paired and combined with learning systems such as for example artificial neural networks. Real vehicle data and/or tire data from a particular tire, vehicle or tire-vehicle system may be provided throughout the life cycle of the respective asset to generate a virtual representation of the vehicle tire for estimation of tire traction, wherein subsequent comparison of the estimated tire traction with a corresponding measured or determined actual tire traction may preferably be implemented as feedback for machine learning algorithms executed at a server level. The tire traction model may in various embodiments utilize the results from prior testing, including for example stopping distance testing results, tire traction testing results, etc., as collected with respect to numerous tire-vehicle systems and associated combinations of values for input parameters (e.g., tire tread, inflation pressure, surface characteristics, vehicle acceleration, slip rate and angle, normal force, braking pressure and load), wherein a tire traction output may be effectively predicted for a given set of current vehicle data and tire data inputs.

In other optional embodiments, the method 200 may also involve providing inputs such as the estimated forces acting on the at least one of the one or more tires 101 or the estimated respective values corresponding to the coefficient of friction, alone or in combination with other relevant metrics, as inputs to a tire durability and health model. Such a model may be implemented for estimating relative fatigue characteristics, for example as an indicator of durability events such as tread/belt separations. Such a model may also for example be implemented for estimating relative tire aging characteristics or predicting wear state at one or more future points in time. Feedback signals corresponding to such durability events may be provided via an interface to the data acquisition device 102 associated with the vehicle itself, or to user computing device 140, such as for example integrating with a user interface configured to provide alerts or notice/recommendations of an intervention event, such as for example that one or more tires should or soon will need to be replaced, rotated, aligned, inflated, and the like. Outputs from a tire durability and health model may further or in the alternative be provided to the traction model referenced above.

Referring to FIG. 2, the model implementation stage associated with the actual vehicle dynamics of the method 200 may continue with a step 250 wherein an output signal corresponding to the estimated respective values corresponding to the coefficient of friction of the surface 160 relative to the one or more tires 101 in contact with the surface 160 is generated. In optional embodiments, the output signal may be provided to a user interface associated with the vehicle for local display to a user of the vehicle, as depicted in step 252, and/or a user interface associated with a remote computing device via, for example, a cloud-based data-management platform, such as a fleet management telematics platform, as depicted in step 254, or a vehicle control unit or an active safety system as depicted in step 260. In the case where the output signal is provided to a vehicle control unit or the active safety system, the estimated respective values corresponding to the coefficient of friction of the surface 160 relative to the one or more tires 101 in contact with the surface 160 may for example be utilized as an input to the tire traction model of the step 242.

In optional embodiments, the method 200 may further involve predicting a value of a coefficient of friction for the surface 160 relative to the one or more tires 101 in contact with the surface 160 at one or more future points in time, wherein the predicted values of the coefficient of friction may be compared to past or current expected vehicle dynamics or past or current actual vehicle dynamics. In other optional embodiments, a feedback signal corresponding to the predicted value of the coefficient of friction may be provided via an interface to an onboard device associated with the vehicle itself, such as the onboard display 252, or to a mobile device associated with a user, such as the remote display 254, to provide alerts or notice/recommendations that a surface condition of the surface 160 may be moving or shifting from a “high” value of a coefficient of friction to a “low” coefficient of friction (or vice versa). Other surface-related events can be predicted and implemented for alerts and/or interventions within the scope of the present disclosure and based on the motion of the at least one of the one or more tires 101, or the vehicle on which the at least one of the one or more tires 101 is mounted, including the longitudinal acceleration, the lateral acceleration, the vertical acceleration due with respect to the normal force (Fz) 154, and the rotations 151, 153, and 155 about the foregoing, as well as the radial acceleration. The system may generate such alerts and/or intervention recommendations based on the foregoing parameters.

In further optional embodiments, cloud-based data-management platforms, such as fleet management systems, may track the surface condition of the surface 160, and the coefficient of friction depending therefrom, of not only specific vehicles and tires, but associated routes, drivers, and the like. Using the tracked surface conditions of the surface 160, and the coefficient of friction depending therefrom, obtained via the methods herein, a fleet manger may for example ascertain which trucks, drivers, routes, and/or tire models are preparing to undergo operation of the vehicle on a “safe” or “dangerous” surface.

Referring to FIG. 2, in optional embodiments, the at least one output signal corresponding to the estimated respective values corresponding to the coefficient of friction of the surface 160 relative to the one or more tires 101, may be incorporated into the active safety system, as depicted in the step 260. The term “active safety system” as used herein may preferably encompass such systems as are generally known to one of skill in the art, including but not limited to examples such a collision avoidance system (CAS), an advanced drive-assistance system (ADAS), an anti-lock braking system (ABS), an active suspension system (ASS), or an adaptive cruise control system (ACCS), etc., and combinations thereof, which can be configured to utilize information pertaining to the estimated respective values corresponding to the coefficient of friction to achieve optimal performance. For example, collision avoidance systems are typically configured to take evasive action, such as automatically engaging the brakes of a host vehicle to avoid or mitigate a potential collision with a target vehicle, and enhanced information regarding the traction capabilities of the tires and accordingly the braking capabilities of the tire-vehicle system are eminently desirable. As yet another example, anti-lock braking systems are typically configured to assist a user in steering in emergency events when undergoing a “skid” or “slide” across the surface 160, such as initiating threshold braking and cadence braking to prevent the one or more tires 101 mounted on the vehicle form “locking up” or “no longer rotating” during a braking event.

In other optional embodiments, a ride-sharing autonomous fleet could use output data corresponding to the estimated respective values corresponding to the coefficient of friction to disable or otherwise selectively remove vehicles undergoing one or more operating events on a surface condition having a “low” value of a coefficient of friction from use during inclement weather, or potentially to limit their maximum speeds or to select preferred, desirable, or alternative route(s) or destination(s) of travel for the vehicles.

Throughout the specification and claims, the following terms take at least the meanings explicitly associated herein, unless the context dictates otherwise. The meanings identified below do not necessarily limit the terms, but merely provide illustrative examples for the terms.

The meaning of “a,” “an,” and “the” may include plural references, and the meaning of “in” may include “in” and “on.”

The phrase “in one embodiment” or “in optional embodiment(s),” “in other optional embodiment(s),” “in further optional embodiments(s),” and “in yet further optional embodiment(s)” as used herein does not necessarily refer to the same embodiment, although it may.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable medium known in the art. An exemplary computer-readable medium can be coupled to the processor such that the processor can read information from, and write information to, the memory/storage medium. In the alternative, the medium can be integral to the processor. The processor and the medium can reside in an ASIC. The ASIC can reside in a user terminal. In the alternative, the processor and the medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the phrase “one or more,” “at least one,” or “one or more of,” when used with a list of items, means that different combinations of one or more of the items may be used and only one of each item in the list may be needed. For example, “one or more of” item A, item B, and item C may include, for example, without limitation, item A or item A and item B. This example also may include item A, item B, and item C, or item B and item C.

Whereas certain preferred embodiments of the present invention may typically be described herein with respect to methods executed by or on behalf of fleet management systems and more particularly for autonomous vehicle fleets or commercial trucking applications, the invention is in no way expressly limited thereto and the term “vehicle” as used herein unless otherwise stated may refer to an automobile, truck, or any equivalent thereof, whether self-propelled or otherwise, as may include one or more tires and therefore require accurate estimation or prediction of tire internal air pressure loss and potential disabling, replacement, or intervention.

The term “user” as used herein unless otherwise stated may refer to a driver, passenger, mechanic, technician, fleet management personnel, or any other person or entity as may be, e.g., associated with a device having a user interface for providing features and steps as disclosed herein.

The previous detailed description has been provided for the purposes of illustration and description. Thus, although there have been described particular embodiments of a new and useful invention, it is not intended that such references be construed as limitations upon the scope of this disclosure. Thus, it is seen that the apparatus and methods of the present disclosure readily achieve the ends and advantages mentioned as well as those inherent therein. While certain preferred embodiments of the disclosure have been illustrated and described for present purposes, numerous changes in the arrangement and construction of parts and steps may be made by those skilled in the art, which changes are encompassed within the scope and spirit of the present disclosure as defined by the appended claims.

1-15. (canceled)

16. A method for estimating respective coefficients of friction between a surface and one or more tires in contact with the surface, the method comprising:
during a testing and model generation stage, generating and storing in data storage one or more models by collecting input data sets representative of motion and one or more operating events of a vehicle and/or at least one tire mounted on the vehicle, wherein an expected motion of the at least one tire is correlated with at least one of the one or more operating events, and at least one surface condition is further associated with each of the one or more models;
during a model implementation stage, for a current vehicle having one or more tires mounted thereon:
detecting one or more operating events on at least one of the one or more tires mounted on the current vehicle;
for at least one of the one or more operating events, receiving at least signals representative of a sensed motion from at least one sensor mounted on the at least one of the one or more tires mounted on the current vehicle;
selectively retrieving from the data storage at least one of the one or more models, based on at least one of the one or more detected operating events on the at least one of the one or more tires mounted on the current vehicle;
estimating respective values corresponding to a coefficient of friction between the surface and each of the one or more tires in contact with the surface based on the at least one model, the at least one of the one or more operating events, and the sensed motion; and
generating at least one output signal corresponding to the estimated respective values corresponding to the coefficient of friction between the surface and each of the one or more tires in contact with the surface.

17. The method of claim 16, wherein:
the one or more operating events comprise at least one of an acceleration of the at least one of the one or more tires mounted on the vehicle, an acceleration of the vehicle on which the at least one of the one or more tires are mounted, a deceleration of the at least one of the one or more tires mounted on the vehicle, a deceleration of the vehicle on which the at least one of the one or more tires are mounted, a steering of the at least one of the one or more tires mounted on the vehicle, or a steering of the vehicle on which the at least one of the one or more tires are mounted, and combinations thereof.

18. The method of claim 16, wherein:
the at least one surface condition comprises a value corresponding to a coefficient of friction.

19. The method of claim 16, further comprising:
determining a saturation point of the at least one of the one or more tires based at least in part on the at least signals representative of the sensed motion, the sensed motion comprising a sensed acceleration.

20. The method of claim 19, further comprising:
estimating respective values corresponding to a coefficient of friction between the surface and each of the one or more tires in contact with the surface based on at least the one or more models, the at least one of the one or more operating events, and a maximum value of the sensed acceleration corresponding to the determined saturation point.

21. The method of claim 19, further comprising:
estimating respective values corresponding to a coefficient of friction between the surface and each of the one or more tires in contact with the surface based on at least the one or more models, the at least one of the one or more operating events, and a change of rate of the sensed acceleration preceding the determined saturation point.

22. The method of claim 16, further comprising:
calculating a torque of the at least one of the one or more tires based at least in part on the at least signals representative of the sensed motion; and
determining a saturation point of the at least one of the one or more tires based at least in part on the calculated torque.

23. The method of claim 22, further comprising:
estimating respective values corresponding to a coefficient of friction between the surface and each of the one or more tires in contact with the surface based on at least the one or more models, the at least one of the one or more operating events, and a change of rate of the calculated torque preceding the determined saturation point.

24. The method of claim 16, further comprising:
determining a footprint length of the at least one of the one or more tires based at least in part on the at least signals representative of the sensed motion; and
estimating respective values corresponding to a coefficient of friction between the surface and each of the one or more tires in contact with the surface based on at least the one or more models, the at least one of the one or more operating events, and the determined footprint length.

25. The method of claim 16, wherein:
the sensed motion comprises at least one of a sensed lateral acceleration, a sensed longitudinal acceleration, or a sensed radial acceleration, and combinations thereof.

26. The method of claim 16, further comprising:
providing the at least one output signal to a user interface connected to the vehicle for display to a user of the vehicle.

27. The method of claim 16, further comprising:
providing the at least one output signal to a user interface connected to a remote computing device via a cloud-based data-management platform.

28. The method of claim 16, further comprising:
using the estimated respective values corresponding to the coefficient of friction as an input to a tire traction detection model.

29. The method of claim 16, further comprising:
providing the at least one output signal to a vehicle control unit connected to an active safety system.

30. The method of claim 29, wherein:
the active safety system comprises at least one of a collision avoidance system (CAS), an advanced drive-assistance system (ADAS), an anti-lock braking system (ABS), an active suspension system (ASS), or an adaptive cruise control system (ACCS), and combinations thereof.

31. A system for estimating respective values corresponding to a coefficient of friction between a surface and each of one or more tires in contact with the surface, the one or more tires mounted on a vehicle, the system comprising:
at least one sensor mounted on at least one of the one or more tires mounted on the vehicle, the at least one sensor configured to receive at least signals representative of a sensed motion of the at least one of the one or more tires mounted on the vehicle based on one or more operating events on the at least one of the one or more tires mounted on the vehicle;
a data storage having stored thereon one or more models, at least one surface condition associated with each of the one or more models, the one or more models having at least an expected motion of the at least one of the one or more tires mounted on the vehicle corresponding to the at least one of the one or more operating events on the at least one of the one or more tires mounted on the vehicle; and
a computing device communicatively linked to the at least one sensor mounted on the at least one of the one or more tires mounted on the vehicle and the data storage, the computing device configured to:
estimate respective values corresponding to a coefficient of friction between the surface and each of the one or more tires in contact with the surface based on at least the one or more models, the at least one of the one or more operating events, and the sensed motion; and
generate at least one output signal corresponding to the estimated respective values corresponding to a coefficient of friction between the surface and each of the one or more tires in contact with the surface.

32. The system of claim 31, wherein:
the one or more operating events comprise at least one of an acceleration of the at least one of the one or more tires mounted on the vehicle, an acceleration of the vehicle on which the at least one of the one or more tires are mounted, a deceleration of the at least one of the one or more tires mounted on the vehicle, a deceleration of the vehicle on which the at least one of the one or more tires are mounted, a steering of the at least one of the one or more tires mounted on the vehicle, or a steering of the vehicle on which the at least one of the one or more tires are mounted, and combinations thereof.

33. The system of claim 31, wherein:
the at least one surface condition comprises a value corresponding to a coefficient of friction.

34. The system of claim 31, wherein:
the computing device is further configured to determine a saturation point of the at least one of the one or more tires mounted on the vehicle based at least in part on the at least signals representative of the sensed motion, the sensed motion comprising a sensed acceleration.

35. The system of claim 34, wherein:
the computing device is further configured to estimate respective values corresponding to a coefficient of friction between the surface and each of the one or more tires in contact with the surface based on at least the one or more models, the at least one of the one or more operating events, and a maximum value of the sensed acceleration corresponding to the determined saturation point.
